(19) United States
(12) Patent Application Publication
(10) Pub. No.: US 2021/0062577 A1
(43) Pub. Date: Mar. 4, 2021

(54) SCREEN ENCLOSURE FRAME COMPONENT ASSEMBLY

(71) Applicant: Thomas G. Hendry, Lehigh Acres, FL (US)

(72) Inventor: Thomas G. Hendry, Lehigh Acres, FL (US)

(21) Appl. No.: 17/011,663

(22) Filed: Sep. 3, 2020

Related U.S. Application Data
(60) Provisional application No. 62/895,243, filed on Sep. 3, 2019.

(51) Int. Cl. E06B 9/52; E06B 7/28

(52) U.S. Cl. CPC E06B 9/52; E06B 2009/527; E06B 7/28

(57) ABSTRACT

A screen enclosure frame component assembly, specifically a base component. The base component comprises an upper element and a lower element. The upper element comprises a groove to retain a spline at an edge of screen material and protrusion adapted to clip onto tabs of the lower element. The lower element further comprises a recessed channel disposed on an intermediate floor and a set of inner legs extending downward from a floor of the recessed channel. The recessed channel allows a fastener to secure the lower element to a supporting surface a lower elevation, thereby providing superior support.

### CLAIM OF PRIORITY

This application is being filed as a non-provisional patent application under 35 U.S.C. § 111(a) and 37 CFR § 1.53(b). This application claims priority under 35 U.S.C. § 111(c) to U.S. provisional patent application Ser. No. 62/895,243 filed on Sep. 3, 2019, the contents of which are incorporated herein by reference.

### FIELD OF INVENTION

The present invention relates to a base component of a screen enclosure frame. More specifically, the base component allows the device to withstand significant forces upon up the screen enclosure and remain secured to the structure upon which it is attached.

### BACKGROUND

A screen enclosure is a common fixture typically surrounding a porch, pool, or other outside area and intended to protect the area from outside elements, such as wind, rain, insects, fallen leaves, and other debris. Typically, screen enclosures are assembled on site and may comprise multiple components, including a metal frame, screen material, and fasteners. The metal frame may comprise extruded lengths of metal, typically an aluminum alloy, that are fastened together to create a support structure adapted for supporting the screen material. In order to secure the metal frame to the ground upon which the screen enclosure rests, the metal frame also comprises a base component that is anchored via fasteners to the supporting surface. The supporting surface is typically concrete, cement, wood, or another construction material able to support the weight of the enclosure and withstand high forces exerted on the structure, which may be caused by wind or other outside factors.

The engagement of the base component to the support structure is a critical factor in the overall performance of the screen enclosure. High winds may cause immense stress upon the base component. Often, the stresses and vibrations upon the base component can cause the fastener to be ripped from the support structure itself. The present disclosure addresses this risk by providing a channel for the fasteners to provide maximum engagement of the supporting surface while exposing a minimal amount of an unengaged portion of the fasteners. Further, the device comprises a cover that hides and protects the unsightly and possibly hazardous fasteners in the channel. The cover itself may comprise a groove for attaching the screen material. Additional details of the present invention are discussed below and displayed in the attached illustrations.

### BRIEF SUMMARY OF INVENTION

It is among the objects of this disclosure to overcome the limitations and defects of the heretofore-known devices by providing inventive features to achieve a base component for a screen enclosure with superior strength and resistance to high-force winds. The disclosure provides a base component comprising an upper element and a lower element. The upper element comprises a groove to retain a spline at an edge of screen material. The upper element further comprises protrusions at a bottom end of the upper element that are adapted to clip onto tabs located on an intermediate floor of the lower element.

In addition to the tabs disposed on the intermediate floor, the lower element further comprises two walls at opposite lateral ends of the lower element. A recessed channel is centrally disposed on the intermediate floor running the length of the lower element between the two walls. The lower element further comprises at least one set of inner legs extending downward from a floor of the recessed channel. The inner legs provide support for the lower element upon a supporting surface to which the lower element is secured. In one embodiment of the disclosure, the lower element is secured to the supporting surface through the application of a fastener through a hole in the recessed channel and into the supporting surface.

The inner legs may be disposed below the floor of the recessed channel at a position inside of channel walls of the recessed channel. This provides additional support to the lower element and prevents the recessed channel from collapsing or buckling upon the fastening of the lower element to the supporting surface. In another embodiment, the inner legs are placed at a distance outside the channel walls of the recessed channel. In a third embodiment, the inner legs are disposed directly below the channel walls of the recessed channel. In yet another embodiment, the lower element comprises two sets of inner legs. The first set of inner legs may be disposed inside the channel walls and the second set of inner legs disposed outside the channel wall, thereby providing superior support upon the fastening of the lower element to the supporting surface.

### BRIEF DESCRIPTION OF THE DRAWINGS

FIG. 1 is a front view of the screen enclosure frame component assembly of the present invention in a fully assembled condition in accordance with one embodiment of the present disclosure.

FIG. 2 is a front view of the lower element of the screen enclosure frame component assembly of the present invention in accordance with one embodiment of the present disclosure.

FIG. 3 is a perspective view of the lower element of the screen enclosure frame component assembly of the present invention in accordance with one embodiment of the present disclosure.

FIG. 4 is a front view of the upper element of the screen enclosure frame component assembly of the present invention in accordance with a first embodiment of the present disclosure.

FIG. 5 is a perspective view of the upper element of the screen enclosure frame component assembly of the present invention in accordance with a first embodiment of the present disclosure.

FIG. 6 is a front view of the upper element of the screen enclosure frame component assembly of the present invention in accordance with a second embodiment of the present disclosure.

FIG. 7 is a front view of the lower element of the screen enclosure frame component assembly of the present invention in accordance with a second embodiment of the present disclosure.

### DETAILED DESCRIPTION OF THE INVENTION

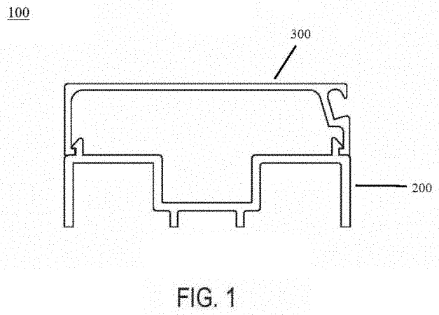

Implementations of the invention provide a screen enclosure frame directed to an assembly of components for use as a frame of a screen enclosure, and in particular, as a base component of the frame. The base component 100 of the present disclosure is shown in the accompanying drawings. As shown in FIG. 1, the base component 100 comprises a lower element 200 and an upper element 300. The base component 100 may comprise a rigid and durable material, such as metal, and in particular, an aluminum alloy. The metal may be manufactured via extrusion techniques known in the art, and therefore, the extruded metal base component 100 may be extruded to any length required for the necessary size of the screen enclosure. The base component 100 may, alternatively, be manufactured from other high strength materials such as polycarbonates, plastics, composites, carbon fiber, and the like. The base component 100 may also be cast, milled, vacuum formed, or manufactured using known techniques, including combinations thereof.

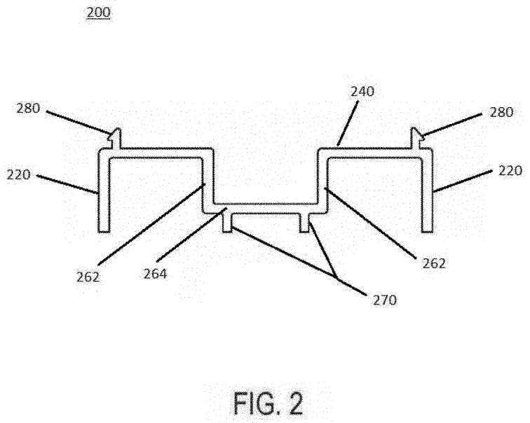

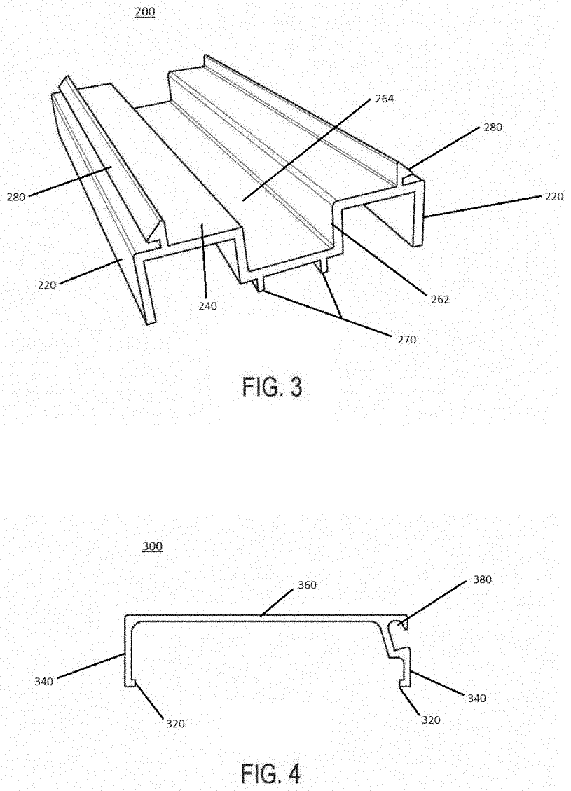

The lower element 200 is shown isolated in FIGS. 2 and 3. The lower element 200 is adapted to engage a supporting surface upon which the screen enclosure rests. The supporting surface may be, but is not limited to, a floor comprising concrete, cement, wood, or other common building materials. In other embodiments, the supporting surface may be a support beam, a column, or ceiling, and may comprise concrete, cement, wood, or any other sturdy and strong material. The lower element 200 comprises two walls 220, one at each of the opposite lateral sides of the lower element 200. The walls 220 of the lower element 200 may have a top end and a bottom end. An intermediate floor 240 may be extend substantially perpendicular to and inward from the top ends of the walls 220. The intermediate floor 240 may have a substantially horizontal orientation and may comprise a recessed channel at a central distance between the two walls 220. The recessed channel may be defined by two channel walls 262, which may be substantially perpendicular to the intermediate floor 240, and a channel floor 264, which may be substantially parallel to the intermediate floor 240. In one embodiment, the channel floor 264 is approximately 0.5 inches below the intermediate floor 240. However, the depth of the recessed channel may range from between just slightly below the intermediate floor 240 to substantially the entirety of the distance between the intermediate floor 240 and the supporting surface.

The recessed channel may further comprise holes within the channel floor 264, whereby a screw may be fastened through the hole and into the supporting surface, securing the lower element 200 to the supporting surface. The recessed channel allows for the lower element 200 to receive the screw at a positon closer to the supporting surface, thereby shortening the amount of the screw that is not secured within the supporting surface. This shortening of the distance between a top portion of the screw that is secured through the hole of the lower element 200 and the supporting surface provides that less torque will be applied to the portion of the screw that is secured within the supporting surface when an outside force is applied to a side of the lower element 200. Therefore, the outside force, such as hurricane force winds, will be less likely to rip out or damage the connection between the screw and the supporting surface, allowing for less maintenance and a longer lifetime to the base component 100.

The recessed channel also provides that a lower amount of the screw will be exposed to the outside elements when the screw is secured within the supporting surface. Further, as distance between the secure point of the screw within the channel floor 264 and the supporting surface is shortened, a shorter screw may be used in connection with this embodiment of the base component 100 than is typically used with screen enclosures. Although, the use of a screw is disclosed above, any type of fastener known in the art may be used to secure the lower element to the supporting surface.

The lower element 200 further comprises at least two inner legs 270 extending downward from the channel floor 264. A bottom tip of the inner legs 270 is adapted to contact the supporting surface and provide support to the lower element 200, when the lower element 200 is fastened to the supporting surface through the hole in the recessed channel. The fastener is attached to the supporting surface through a hole at a position between the at least two inner legs 270. In one embodiment, the inner legs 270 are disposed on the channel floor 264 at a location inside and below channel walls 262. The shorter distance between the inner legs 270 compared to that of the channel walls 262 allows for additional support to the lower element 200 by preventing the collapse or buckling of the recessed channel and the inner legs 270 when the fastener is secured through the hole of the channel floor 264 to the supporting surface. In another embodiment, the inner legs extend downward from the channel floor 264 at a location directly below the channel walls 262. A third embodiment of the lower element 200 is shown in FIG. 7, whereby the lower element 200 comprises two sets of inner legs 270. A first set of the inner legs are positioned at a longitudinal location between the channel walls 262 and a second set of inner legs is positioned at a longitudinal location outside of the channel walls 262, thereby providing superior support for the lower element 200.

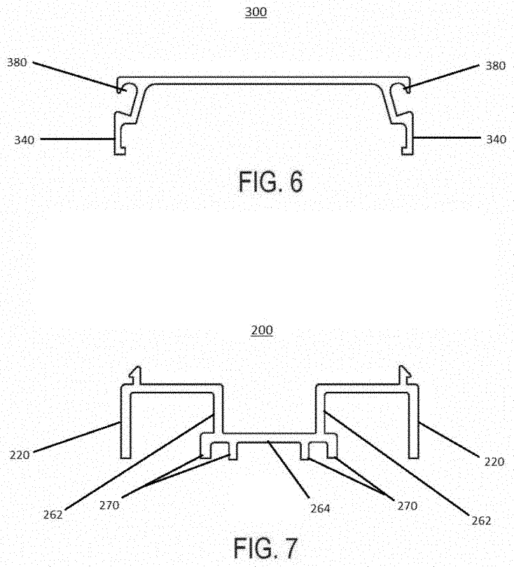

The lower element 200 further comprises at least two tabs 280 at opposite lateral ends of the intermediate floor 240. The tabs 280 are aligned with and adapted to engage protrusions 320 (as shown in FIG. 6) of the upper element 300, thereby securing the upper element 300 to the lower element 200. The tabs 280 may be able to flex inward when the protrusions 320 are forced down upon the tabs 280, and thereafter snap back into their original position, securing the protrusions 320 below the tabs 280. Alternatively, the protrusions may flex outward when forced upon the tabs 280, and thereafter snap back to their original position, securing the protrusions 320 below the tabs 280.

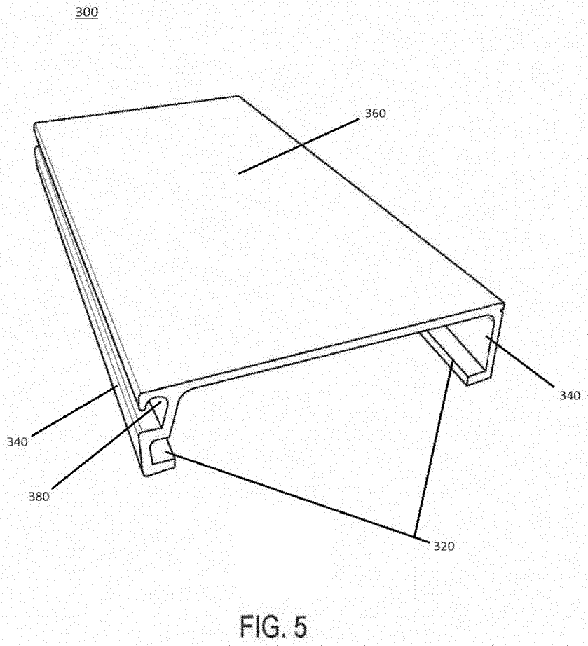

The upper element 300 is shown isolated in FIGS. 4 and 5. The upper element 300 comprises two sidewalls 340 at opposite laterals ends and a top floor 360 extending between upper ends of the sidewalls 340. In one embodiment the protrusions 320 of the upper element 300 are disposed at bottom tips of the sidewalls 340. However it is within the scope of this invention that the protrusions 320 may be disposed at any height on an inside face of the sidewalls 340 or the protrusions 320 may extend at any position downward from the top floor 360.

The upper element 300 is further comprised of a groove 380 disposed in at least one sidewall 340. Screen material of a screen enclosure typically comprises a spline that allows the screen material to be easily secured in a frame of a screen enclosure by the application of force. The groove 380 is adapted to receive a spline for securing screen material. The groove 380 may be disposed proximate the top floor 360. This location of the groove 380 provides the advantage of allowing only a minimal amount of the screen material and the base component 100 to come into contact. Contact between the screen material and the base component 100 may cause the screen to rip or be cut upon the metal surface due to friction or imperfections in the material of the base component 100. Further, the space between the screen material and the base component may trap dirt, sediment, and other unwanted material. The accumulation of this unwanted material may lead to the growth of bacteria or fungus, which may become unsightly or cause unpleasant odors, which require the replacement of the screen material itself.

In another embodiment, as shown in FIG. 6, a grove 380 may be disposed on both of the sidewalls 340 of the upper element 300. This allows for a symmetric configuration, which aids in the installation of the upper element 300 unto the lower element 200, as the orientation of the position of the groove 380 does not need to be specified. Screen material may be installed on either side of the lower element 200, or on both sides.

The upper element 300 offers the further advantage over existing devices by providing a more aesthetic finish to the base component 100 by covering and hiding the fasteners securing the lower element 200 to the supporting surface. Further, while the recessed channel may house the majority of a head of a fastener, if the head extends beyond the intermediate floor 240 of the lower element 200, the upper element 300 will effectively cover the remainder of the head of the fastener. The upper element 300 also prevents water and other debris from contacting the fastener within the recessed channel of the lower element 200, which prevents the fastener from potentially corroding and weakening the connection with the supporting surface.

In one embodiment, the upper element 300 and the lower element 200 are comprised of the same material. In other embodiments, the lower element 200 and upper element 300 may be comprised of different material, wherein the lower element 200 is comprised of a stronger material than the material of the upper element 300. For example, the lower element 200 may be comprised of a metal alloy, while the upper element may be comprised of a high-strength polymer. This may allow for lower costs and less overall weight of the base component 100.

In installing the base component 100, the lower element 200 is first secured to the supporting surface at a desired location. Upon the fastening of the lower element 200 to the supporting surface, the upper element 300 is aligned over the length lower element 200. Force is applied upon the upper element 300, forcing the protrusions 320 of the upper element 300 to clip under the tabs 280 of the lower element 200.

Any reference in this specification to “one embodiment,” “an embodiment,” an “example embodiment,” etc., means that a particular feature, structure, or characteristic described in connection with the implementation is included in at least one embodiment of the invention. The appearances of such phrases in various places in the specification are not necessarily referring to the same embodiment. In addition, any elements or limitations of any invention or embodiment thereof disclosed herein can be combined with any and/or all other elements or limitations (individually or in any combination) or any invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

1. A device comprising:
a lower element comprising two sidewalls at opposite lateral ends of the lower element, wherein a bottom tip of the sidewalls are in contact with a supporting surface below the lower element, an intermediate surface substantially perpendicular to the sidewalls extending between the sidewalls, a recessed channel in the intermediate surface, at least two tabs extending substantially upward from an upper face of the intermediate surface, a hole therethrough a floor of the recessed channel, and at least two inner legs extending from a bottom surface of the floor of the recessed channel to the supporting surface;
an upper element comprising a top surface, two walls at lateral ends of the upper element extending below the top surface, at least two protrusions extending inwardly from the two walls, and at least one retention groove on the outward surface of at least one wall of the upper element;
wherein a fastener is disposed through the hole in the floor of the recessed channel and into the supporting surface, thereby securing the lower element to the supporting surface;
wherein the protrusion of the upper element are adapted to engage the tabs of the lower element, thereby securing the upper element to the lower element; and
wherein the retention groove is adapted to receive a spline on an edge of screen material.

2. The device of claim 1, wherein the inner legs are disposed at a location below and between the sides of the recessed channel.

3. The device of claim 1, wherein the distance between the inner legs is greater than the distance between sides of the recessed channel.

4. The device of claim 1, wherein the inner legs are disposed at a location below and outside the sides of the recessed channel.

5. The device of claim 1, wherein the lower element comprises two sets of inner legs, where one set of inner legs is disposed at a location below and between the sides of the recessed channel and the second set of inner legs is disposed at a location below and outside the sides of the recessed channel.

6. The device of claim 1, wherein a retention groove is located on the outward surface of both walls of the upper element.

7. The device of claim 1, wherein the lower element and the upper element are comprised of the same material.

8. The device of claim 7, wherein the lower element and the upper element are comprised of aluminum alloy.

9. The device of claim 1, wherein the lower element and the upper element are comprised of different materials.
